(19) United States
(12) Patent Application Publication
(10) Pub. No.: US 2011/0220473 A1
(43) Pub. Date: Sep. 15, 2011

(54) SWITCH, METHOD OF MANUFACTURING THE SAME, AND RELAY

(75) Inventors: Naoki Yoshitake, Otsu-shi (JP); Takahiro Masuda, Kizugawa-shi (JP)

(73) Assignee: OMRON CORPORATION, Kyoto-shi (JP)

(21) Appl. No.: 13/035,073

(22) Filed: Feb. 25, 2011

(30) Foreign Application Priority Data
Mar. 10, 2010 (JP) 2010-052641

(51) Int. Cl. H01H 3/32; H01H 57/00; H01H 11/00

(52) U.S. Cl. 200/181; 200/508; 29/622

(57) ABSTRACT

A switch has a first contact portion in which a plurality of conductive layers is stacked on an upper side of a first substrate, and a second contact portion in which a plurality of conductive layers is stacked on an upper side of a second substrate. Respective end faces of the conductive layers at the first contact portion are contacts of the first contact portion. Respective end faces of the conductive layers at the second contact portion are contacts of the second contact portion. Each contact of the first contact portion and each contact of the second contact portion are faced to each other so that the contacts come into contact with or separate from each other.

### BACKGROUND OF THE INVENTION

1. Technical Field

The present invention relates to switches, manufacturing methods of the same, and electrostatic relays. Specifically, the present invention relates to a switch in which a surface perpendicular to a moving direction of a movable contact portion is a contact and a manufacturing method of the same, and an electrostatic relay using the structure of the switch.

2. Related Art

With switches and relays, the switches and relays do not operate if the contacts are welded to each other, and hence countermeasures for the welding of the contacts are important. One of the countermeasures for avoiding the welding of the contacts includes using a contact material having as a high hardness as possible.

The opposing area of the contacts needs to be made large in order to stably bring the contacts into contact with each other even when there is processing error in the contact or there is variance in the movement for every operation of the movable contact. The thickness of the conductive layer is to be increased to realize a large opposing area of the contacts if the side surface of the conductive layer formed on the surface of the substrate is the contact. Thus, in such contact structure, the thickness of the conductive layer formed on the substrate is to be made large in order to stably bring the contacts into contact with each other.

However, when forming the conductive layer (contact) having a large thickness using the contact material of high hardness, the internal stress of the conductive layer becomes large and the heat stress generated between the substrate and the conductive layer due to temperature change and the like becomes large, and thus the conductive layer tends to easily strip from the substrate. It is also difficult to form the conductive layer if the conductive layer is thick. Therefore, it is conventionally difficult to form a contact having a large opposing area using the contact material of high hardness.

An MEMS switch in which a surface perpendicular to the moving direction of the movable contact portion is the contact (contacting surface) is disclosed in Japanese Unexamined Patent Publication No. 2006-526267. In such MEMS switch, a conductive layer is formed by plating from the upper surface to the end face of an insulating layer formed on the upper surface of the substrate, and the projecting portion of the conductive layer becomes the movable contact. In such structure of the contact, however, it is difficult to increase the thickness of the conductive layer having high hardness, and the conductive layer tends to easily strip if the thickness of the conductive layer having high hardness is increased.

### SUMMARY

One or more embodiments of the present invention provides a switch capable of forming a contact with large opposing area using a contact material of high hardness, a manufacturing method of the same, and an electrostatic relay using the structure of the switch.

A switch according to one or more embodiments of the present invention includes a first contact portion in which a plurality of conductive layers is stacked on an upper side of a first substrate, and a second contact portion in which a plurality of conductive layers is stacked on an upper side of a second substrate; wherein respective end faces of the conductive layers at the first contact portion are contacts of the first contact portion; respective end faces of the conductive layers at the second contact portion are contacts of the second contact portion; and each contact of the first contact portion and each contact of the second contact portion are faced to each other so that the contacts come into contact with or separate from each other.

In the switch according to one or more embodiments of the present invention, the contact area of the first contact portion can be increased by increasing the number of conductive layers at the first contact portion and the contact area of the second contact portion can be increased by increasing the number of conductive layers at the second contact portion since the first contact portion is formed by stacking a plurality of conductive layers and the second contact portion is formed by stacking a plurality of conductive layers. Furthermore, the contact stability of the contacts can be stabilized even if there is operation variation every time the contacts are open/close operated, and the contacting position of the contact is dispersed so that the breakage of the contact is less likely to occur. Therefore, the opposing areas of the contacts increase, the contacting position of the contact of the first contact portion and the contact of the second contact portion is dispersed, so that breakage of the contact contacting part is less likely to occur. The wiring resistance of the conductive layer (wiring portion) at the first contact portion and the second contact portion can also be reduced.

Furthermore, the thickness of each conductive layer does not need to be thickened to increase each contact area of the first contact portion and the second contact portion if the number of conductive layers to stack is increased, and thus the internal stress in the first contact portion and the second contact portion can be reduced. Therefore, even if a material of high hardness in which welding (sticking) is less likely to occur is used for the material of the conductive layer (contact), the possibility each conductive layer will strip from the substrate due to internal stress generated in the manufacturing process and heat stress by temperature change lowers. In particular, since the first contact portion is formed by stacking a plurality of conductive layers on the upper side of the first substrate and the second contact portion is formed by stacking a plurality of contact layers on the upper side of the second substrate, the stripping becomes more unlikely to occur by stacking each conductive layers through a layer softer and having smaller specific resistance than the conductive layer, a layer made from a material having satisfactory workability, a layer having satisfactory adhesiveness, or the like.

In a switch according to one or more embodiments of the present invention, the conductive layer and a buffer layer having a hardness smaller than the conductive layer are alternately stacked with each other in the first contact portion and the second contact portion. Accordingly, the welding between the contacts is less likely to occur and the lifespan of the contact is lengthened since the conductive layer including the contact can be formed with a material of high hardness. Furthermore, the impact in the case where the contacts come into contact with each other can be alleviated by the buffer layer since the buffer layer having a relatively low hardness is arranged between the conductive layers. The conductive layer is more unlikely to strip from the substrate since the distortion of the conductive layer can be alleviated by the buffer layer. Furthermore, the contact stability of the contacts can be enhanced since the opposing areas (total thickness of the end faces of the conductive layers) of the contacts in total can be increased. The wiring resistance can be lowered since the material of low specific resistance can be selected for the buffer layer irrespective of the hardness.

In a switch according to one or more embodiments of the present invention, the end face to become the contact in the conductive layer is projected out than an end face of the buffer layer in the first contact portion and the second contact portion. Accordingly, the contact of the first contact portion and the contact of the second contact portion can be prevented from causing contact failure when the buffer layer of the first contact portion and the buffer layer of the second contact portion come into contact with each other since the end face of the conductive layer of both contact portions is projected out than the end face of the buffer layer. Since the contact between the buffer layers and the contact between the conductive layer and the buffer layer can be prevented between the first contact portion and the second contact portion, the sticking between the buffer layers and the sticking between the buffer layer and the conductive layer can be prevented.

In a switch according to one or more embodiments of the present invention, a thickness of the conductive layer configuring the first contact portion is thicker than a thickness of the buffer layer configuring the second contact portion. Accordingly, the conductive layer of the first contact portion can be prevented from fitting in between the conductive layers of the second contact portion and causing sticking of the first contact portion and the second contact portion.

In a switch according to one or more embodiments of the present invention, a thickness of the conductive layer configuring the second contact portion is thicker than a thickness of the buffer layer configuring the first contact portion. Accordingly, the conductive layer of the second contact portion can be prevented from fitting in between the conductive layers of the first contact portion and causing sticking of the first contact portion and the second contact portion.

In a switch according to one or more embodiments of the present invention, the conductive layer in the first contact portion and the second contact portion is made of Pt, Pd, Ir, Ru, Rh, Re, Ta, Ag, Ni, Au, or an alloy thereof. Accordingly, the contact resistance between the contacts can be further reduced since the specific resistance of the conductive layer can be reduced.

A first method of manufacturing a switch according to one or more embodiments of the present invention includes the steps of forming a mold portion of a predetermined pattern on an upper side of a substrate; alternately stacking one or a plurality of buffer layers and a plurality of conductive layers on an upper side of the substrate by growing the buffer layers and the conductive layers in a thickness direction of the substrate in a plurality of regions excluding a region formed with the mold portion at the upper side of the substrate; removing the mold portion and forming a surface to become a contact with a surface coming into contact with a side surface of the mold portion of the conductive layer; and dividing the substrate into plurals in accordance with the plurality of regions in which the buffer layers and the conductive layers are stacked.

In the first manufacturing method according to one or more embodiments of the present invention, the end face of the conductive layer to become the contact can be smoothly formed by the mold portion, and the contact resistance between the contacts can be reduced. The gap distance between the contact of the first contact portion and the contact of the second contact portion can be controlled by the width of the mold portion, so that the variation in the gap distance between the contacts can be reduced and the inter-contact distance can be narrowed.

A second method of manufacturing a switch according to one or more embodiments of the present invention includes the steps of alternately stacking buffer layers and conductive layers on an upper side of a substrate by growing the buffer layers and the conductive layers in a thickness direction of the substrate at the upper side of the substrate; forming a mold portion of a plurality of regions on the stacked buffer layers and the conductive layers; etching the buffer layers and the conductive layers with the mold portion as a mask to divide the buffer layers and the conductive layers into plurals and forming a surface to become a contact with the etched surface of the conductive layer; and dividing the substrate into plurals in accordance with the divided regions of the buffer layers and the conductive layers.

In the second manufacturing method according to one or more embodiments of the present invention, the end face of the conductive layer to become the contact can be smoothly formed by etching the stacked conductive layer and the buffer layer, and the contact resistance between the contacts can be reduced. The gap distance between the contact of the first contact portion and the contact of the second contact portion can be controlled by the width of the exposed portion from the mold portion, so that the variation in the gap distance between the contacts can be reduced and the inter-contact distance can be narrowed.

An electrostatic relay according to one or more embodiments of the present invention includes the switch according to one or more embodiments of the present invention and an actuator for moving at least one contact portion of the first contact portion or the second contact portion in a direction perpendicular to the contact thereof so that the contact of the first contact portion and the contact of the second contact portion are brought into contact with or separate from each other. In the electrostatic relay according to one or more embodiments of the present invention, the welding between the contacts is less likely to occur since the material of high hardness is used for the contact, and the stripping between the conductive layers is less likely to occur even if the total opposing areas of the contacts is increased. The contact stability of the contacts is also obtained as the opposing areas of the contacts are increased.

According to one or more embodiments of the present invention, welding becomes less likely to occur by using a material of high hardness for the contact. Furthermore, the stripping of the conductive layer from the substrate and the stripping between the conductive layers are less likely to occur even if the material of high hardness is used for the contact and the opposing areas of the contacts made from a material of high hardness can be increased since the conductive layers are stacked with the buffer layer interposed therebetween to increase the opposing areas of the contacts. The contact stability of the contact can be stabilized even if there is operation variation every time the contact is open/close operated, and the contacting position of the contact is dispersed so that the breakage of the contact is also less likely to occur by increasing the opposing area of the contact. The wiring resistance of the first and second contact portions can be reduced by using a material of small specific resistance for the buffer layer.

### BRIEF DESCRIPTION OF THE DRAWINGS

FIG. 1 is a cross-sectional view showing a structure of a switch according to a first embodiment of the present invention;

FIGS. 2A to 2D are schematic cross-sectional views describing a manufacturing method of a switch of the first embodiment;

FIGS. 3A to 3D are schematic cross-sectional views showing the steps following FIG. 2D;

FIGS. 4A to 4D are schematic cross-sectional views describing another manufacturing method of a switch of the first embodiment;

FIGS. 5A to 5C are schematic cross-sectional views describing another manufacturing method of a switch of the first embodiment, showing the process following FIG. 4D;

FIGS. 6A to 6C are schematic cross-sectional views describing another manufacturing method of a switch of the first embodiment, showing the process following FIG. 5C;

FIG. 7 is a cross-sectional view showing a structure of a switch according to a second embodiment of the present invention;

FIGS. 8A to 8D are schematic cross-sectional views describing a manufacturing method of the switch of the second embodiment;

FIGS. 9A to 9C are schematic cross-sectional views showing the process following FIG. 8D;

FIGS. 10A to 10C are schematic cross-sectional views showing the process following FIG. 9C;

FIG. 11 is a plan view showing an electrostatic relay according to a third embodiment of the present invention;

FIG. 12 is a perspective view showing portion A of FIG. 11 in an enlarged manner;

FIG. 13 is a perspective view showing the fixed contact portion and the movable contact portion of the electrostatic relay according to the third embodiment in an enlarged manner; and

FIG. 14 is a schematic cross-sectional view taken along line B-B of FIG. 11.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. It should be recognized that the present invention is not limited to the following embodiments, and various design changes can be made within a scope of the invention.

### First Embodiment

### (Structure)

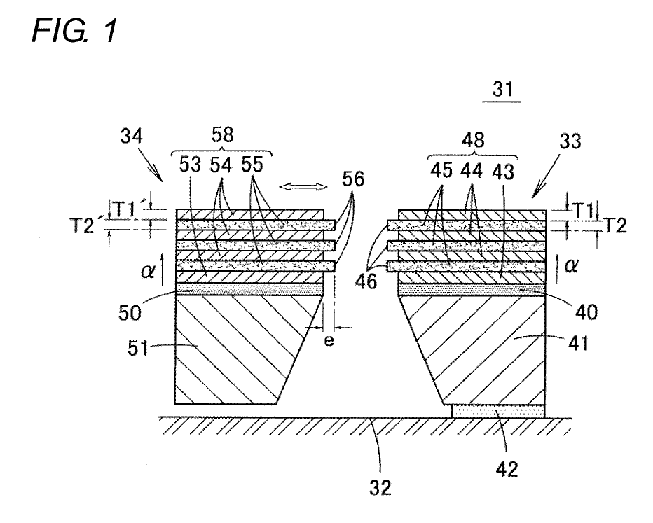

FIG. 1 is a cross-sectional view showing a structure of a switch according to a first embodiment of the present invention. A switch 31 includes a fixed contact portion 33 and a movable contact portion 34. The fixed contact portion 33 has the lower surface fixed to the upper surface of a base substrate 32 by way of an insulating film 42, and the movable contact portion 34 is floating from the upper surface of the base substrate 32 and moves in a direction (direction shown with an outlined arrow) parallel to the upper surface of the base substrate 32 by a drive mechanism or an actuator. For instance, the switch according to one or more embodiments of the present invention can also be used in an MEMS switch having the structure disclosed in patent document 1.

The fixed contact portion 33 has a wiring pattern 48 arranged on the upper surface of a fixed contact substrate 41 having the surface covered with an insulating layer 40. The wiring pattern 48 includes a base layer 43 positioned on the upper surface of the insulating layer 40, and a plurality of sets of a conductive layer 45 and a buffer layer 44 alternately stacked thereon. The movable contact portion 34 has a wiring pattern 58 arranged on the upper surface of a movable contact substrate 51 having the surface covered with an insulating layer 50. The wiring pattern 58 includes a base layer 53 positioned on the upper surface of the insulating layer 50, and a plurality of sets of a conductive layer 55 and a buffer layer 54 alternately stacked thereon. The base layers 43, 53 are metal material layers and are formed through vapor deposition, sputtering, non-electrolytic plating, and the like. The buffer layers 44, 54 are formed by growing the conductive material in the thickness direction by electrolytic plating or non-electrolytic plating, vapor deposition, sputtering, and the like. The conductive layers 45, 55 are formed by growing the metal material in the thickness direction (direction a of arrow in FIG. 1) by electrolytic plating or non-electrolytic plating, vapor deposition, sputtering, and the like.

The ends on the respectively opposing sides of the conductive layers 45, 55 project out from the end faces of the buffer layers 44, 54 and the base layers 43, 53, respectively. The opposing surfaces of the conductive layers 45, 55 become a fixed contact 46 (electrical contacting surface) and a movable contact 56 (electrical contacting surface), and are both smoothly formed. Each fixed contact 46 is on the same plane perpendicular to the upper surface of the fixed contact substrate 41, each movable contact 56 is on the same plane perpendicular to the upper surface of the movable contact substrate 51, and the fixed contact 46 and the movable contact 56 are formed parallel to each other. Each fixed contact 46 and each movable contact 56 are positioned at the same height, so that the contacts 46, 56 respectively come into contact with each other over substantially the entire surfaces thereof when the movable contact portion 34 is moved in parallel to close the contacts 46, 56. The fixed contact 46 and the movable contact 56 may not necessarily be a plane, and may be a curved surface.

According to one or more embodiments of the present invention, the material of the buffer layers 44, 54 and the conductive layers 45, 55 have a small specific resistance as the contact resistance and the wiring resistance of the fixed contact portion 33 and the movable contact portion 34 are as small as possible. The fixed contact 46 and the movable contact 56 are less likely to cause sticking (fixation) at the time of contact and the lifespan of the switch 31 becomes longer as the material is harder, and thus the material of the conductive layers 45, 55 according to one or more embodiments of the present invention has a high hardness. The buffer layers 44, 54, on the contrary, according to one or more embodiments of the present invention, are made of material that is soft to a certain extent since the deformation of the conductive layers 45, 55 at the time of contact between the contacts can be alleviated if the buffer layers are soft to a certain extent (soft to an extent where deformation does not occur by the contacting force of the fixed contact 46 and the movable contact 56). Therefore, the material having small specific resistance and higher hardness than that of the buffer layers 44, 54 is used for the material of the conductive layers 45, 55, and Pt, Pd, Ir, Ru, Rh, Re, Ta, Ag, Ni, Au, or an alloy thereof can be used. The material having small specific resistance and lower hardness than that of the conductive layers 54, 55 is used for the material of the buffer layers 44, 54, and Au, Ag, Al, or an alloy thereof can be used. The metal material is preferable but a non-metal conductive material such as polysilicon may be used for the buffer layers 44, 54.

Specifically, the specific resistance of the conductive layers 45, 55 according to one or more embodiments of the present invention is smaller than or equal to 20μΩ·cm (at 20° C.), but the specific resistance is desirably as small as possible in such range. The specific resistance of the buffer layers 44, 54 according to one or more embodiments of the present invention is smaller than or equal to 50μΩ·cm (at 20° C.), but the specific resistance is desirably as small as possible in such range.

The hardness of the conductive layers 45, 55 according to one or more embodiments of the present invention is greater than or equal to 30 and smaller than or equal to 2000. The hardness of the buffers 44, 54 according to one or more embodiments of the present invention is greater than or equal to 10 and smaller than or equal to 1500. Such hardness is expressed in dynamic hardness H, which is a unit of hardness in dynamic ultra micro hardness tester manufactured by Shiamdzu Co.

If the thickness T2 of the conductive layer 45 is thinner than the thickness T1′ of the buffer layer 54 or if the thickness T2′ of the conductive layer 55 is thinner than the thickness T1 of the buffer layer 44, the distal end of the conductive layer 45 gets fitted between the conductive layers 55 or the distal end of the conductive layer 55 gets fitted between the conductive layers 45 thereby causing sticking of the conductive layer 45 and the conductive layer 55 and shortening the lifespan of the switch 31 when the movable contact portion 34 is brought into contact with the fixed contact portion 33 and the height of each other is shifted. In order to prevent such phenomenon, the thickness T2 of the conductive layer 45 is to be made greater than the thickness T1′ of the buffer layer 54 (T2>T1′) and the thickness T2′ of the conductive layer 55 is to be made thicker than the thickness T1 of the buffer layer 44 (T2′>T1).

The thicknesses of the conductive layers 45, 55 and the buffer layers 44, 54 are to be increased in order to reduce the contact resistance of the fixed contact 46 and the movable contact 56 and the wiring resistance of the fixed contact portion 33 and the movable contact portion 34, but the conductive layers 44, 55 and the buffer layers 44, 54 may strip by internal stress at the time of manufacturing, heat stress from temperature change (difference in linear coefficient of expansion), and the like if the thicknesses are too thick. Therefore, the thickness T2, T2′, T1, T1′ of each layer of the conductive layers 45, 55 and the buffer layers 44, 54 is thinner than about 10 μm, and the entire thickness (total thickness) of the conductive layers 45, 55 and the buffer layers 44, 45 is increased by increasing the number of layers to reduce the resistance. The upper limit for the number of layers of the conductive layers 45, 55 and the number of layers of the buffer layers 44, 54 does not particularly exist as long as manufacturing process and cost are acceptable.

In such switch 31, the conductive layers 45, 55 project out compared to the end faces the buffer layers 44, 54 and the base layers 43, 53, and thus the contact of the fixed contact 46 and the movable contact 56 is not inhibited when the buffer layers 44, 54 hit each other or the base layers 43, 53 hit each other before the fixed contact 46 and the movable contact 56 come into contact with each other. Furthermore, since the contact of the buffer layers 44, 54 is inhibited when the fixed contact 46 and the movable contact 56 come into contact with each other, the buffer layers 44, 54 do not adhere to each other and the lifespan of the contact is not influenced even when a material of low hardness or a relatively soft material is used for the buffer layers 44, 54.

Therefore, the projecting length e of the conductive layers 45, 55 is desirably as large as possible, but the processing may become difficult or the strength may too low if too long. Therefore, the projecting length e of the conductive layers 45, 55 is determined in view of the wear volume, the strength, the workability, and the like of the conductive layers 45, 55. The projecting amount e of the conductive layers 45, 55 merely needs to be greater than or equal to 0.1 μm since the wear volume of the conductive layers 45, 55 in the case where the switching operation is repeated is smaller than 0.1 μm.

The fixed contact 46 and the movable contact 56 are projecting out from each end face of the fixed contact substrate 41 and the insulating layer 40 and each end face of the movable contact substrate 51 and the insulating layer 50, and the opposing surfaces of the fixed contact substrate 41 and the movable contact substrate 51 are both inclined to retreat to the back side toward the lower surface side. Therefore, when moving the movable contact portion 34 to bring each movable contact 56 to come into contact with each fixed contact 46, the contact of the movable contact 56 and the fixed contact 46 is not inhibited when the fixed contact substrate 41 and the movable contact substrate 51 come into contact with each other or the insulating layer 40 and the insulating layer 50 come into contact with each other.

(First Manufacturing Method)

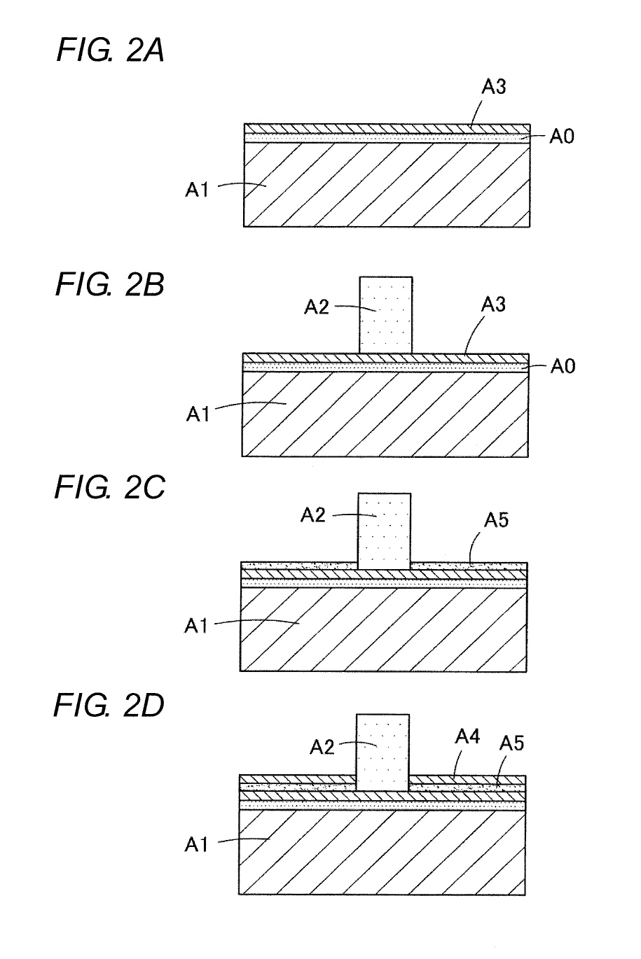

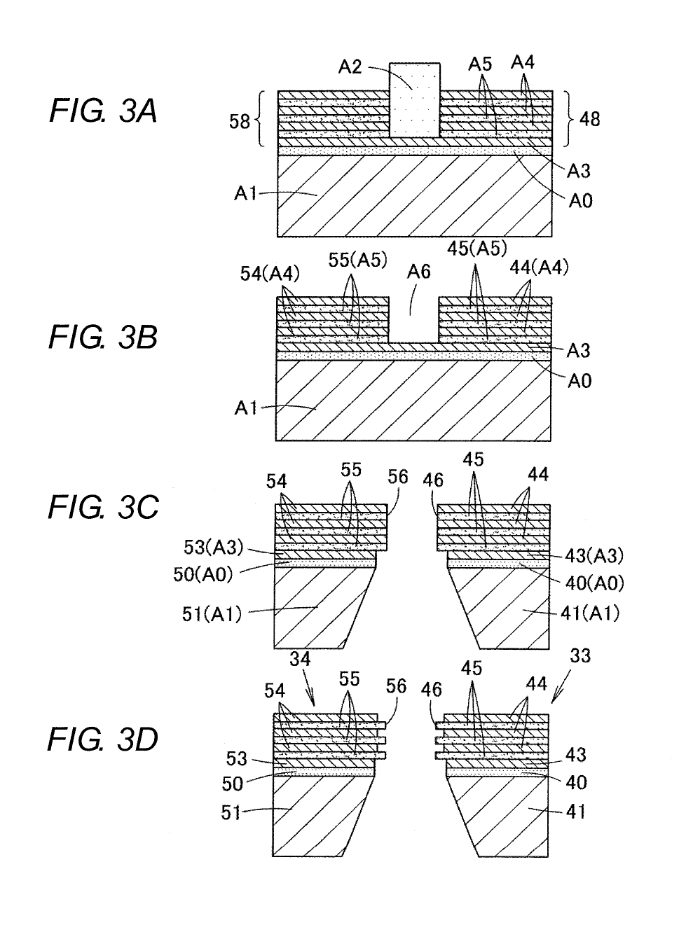

The switch 31 is manufactured using the MEMS (Micro Electrical-Mechanical Systems) technique. FIGS. 2A to 2D and FIGS. 3A to 3D show one example of a manufacturing process of the switch 31, where the conductive layers 45, 55 are formed by electrolytic plating.

In FIG. 2A, an insulating layer A0 is formed on an upper surface of a substrate A1 made of Si, and a plated base layer A3 is formed thereon. The plated base layer A3 has metal material formed on the upper surface of the insulating layer A0 through methods such as vapor deposition, sputtering, and non-electrolytic plating. The plated base layer A3 becomes a plated electrode, and has a two-layer structure including a lower layer Cr/upper layer Au.

Then, as shown in FIG. 2B, a mold portion A2 is arranged on the upper surface of a substrate A1 in a region other than the region to form the wiring patterns 48 and 58. The mold portion A2 uses a material that has resistance to plating solution and that is selectively removed by etching without corroding the conductive layer A5 and the buffer layer A4, the plated base layer A3, and the insulating layer A0 in the subsequent mold portion removing step. To form the mold portion A2, the photoresist applied on the upper surface of the substrate A1 from above the plated base layer A3 is exposed through the exposure mask and etched for patterning. The mold portion A2 patterned in such manner has both side surfaces parallel to each other and smooth in an intermediate region of the plated base layer A3 of the region formed with the wiring pattern 48 and the plated base layer A3 of the region formed with the wiring pattern 58. The mold portion A2 has a height sufficiently larger than the thicknesses of the wiring patterns 48, 58 to be formed on the substrate A1.

The plating process is performed on the substrate A1 formed with the mold portion A2 in the following manner. The substrate A1 is immersed in a plating solution to perform electrolytic plating with the plated base layer A3 as the plated electrode, so that the plated metal particles such as Pt precipitate on the surface of the plated base layer A3 and the conductive layer A5 grows in the thickness direction of the substrate A1, as shown in FIG. 2C. The plated metal particles do not precipitate in the region covered with the mold portion A2.

Then, as shown in FIG. 2D, a buffer layer A4 is stacked on the conductive layer A5. The method of stacking the buffer layer A4 may be a method of immersing in different plated solutions, and precipitating the buffer layer A4 on the conductive layer A5 with the conductive layer A5 as the plated electrode, or may be a method of forming the buffer layer A4 on the conductive layer A5 by vapor deposition, sputtering, and the like.

The process of FIG. 2C and the process of FIG. 2D are repeated plural times, and when the wiring pattern 48 and the wiring pattern 58 are respectively formed in the region other than the mold portion A2 as shown in FIG. 3A, the mold portion A2 is removed by etching as shown in FIG. 3B. As a result, the wiring pattern 48 including the conductive layer 45 (A5), the buffer layer 44 (A4) and the base layer A3, and the wiring pattern 58 including the conductive layer 55 (A5), the buffer layer 54 (A4), and the base layer A3 (the plated base layer A3 is not divided to the base layer 43 and the base layer 53 at this stage) are formed on the upper surface of the substrate A1. The end faces of the conductive layers 45, 55 coming into contact with the mold portion A2 are formed smoothly and parallel to each other.

Thereafter, the plated base layer A3 and the insulating layer A0 in the space A6 are etched to be respectively divided to the base layer 43 and the base layer 53, and to the insulating layer 40 and the insulating layer 50. The substrate A1 is etched from the lower surface side to be divided to the fixed contact substrate 41 and the movable contact substrate 51, as shown in FIG. 3C. The end of the buffer layer 44 is then selectively etched by the etchant entered into the space A6 after the mold portion A2 is removed, so that the buffer layer 44 is etched back, the ends of the conductive layers 45, 55 are projected out, and the fixed contact 46 and the movable contact 56 are formed at the end faces thereof, as shown in FIG. 3D. The buffer layer 44 is etched back after the plated base layer A3, the insulating layer A0 and the substrate A1 are divided, but the plated base layer A3, the insulating layer A0 and the substrate A1 may be divided after the buffer layer 44 is etched back.

Therefore, one block becomes the fixed contact portion 33 in which the insulating layer 40, the fixed contact substrate 41, the base layer 43, the buffer layer 44, and the conductive layer 45 are stacked. The fixed contact portion 33 is fixed on the upper surface of the base substrate 32 through the insulating film 42. The other block becomes the movable contact portion 34 in which the insulating layer 50, the movable contact substrate 51, the base layer 53, the buffer layer 54, and the conductive layer 55 are stacked. The movable contact portion 34 is lastly separated from the base substrate 32 by removing the insulating film at the lower surface by etching. The switch 31 (MEMS switch) is manufactured as a result.

(Second Manufacturing Method)

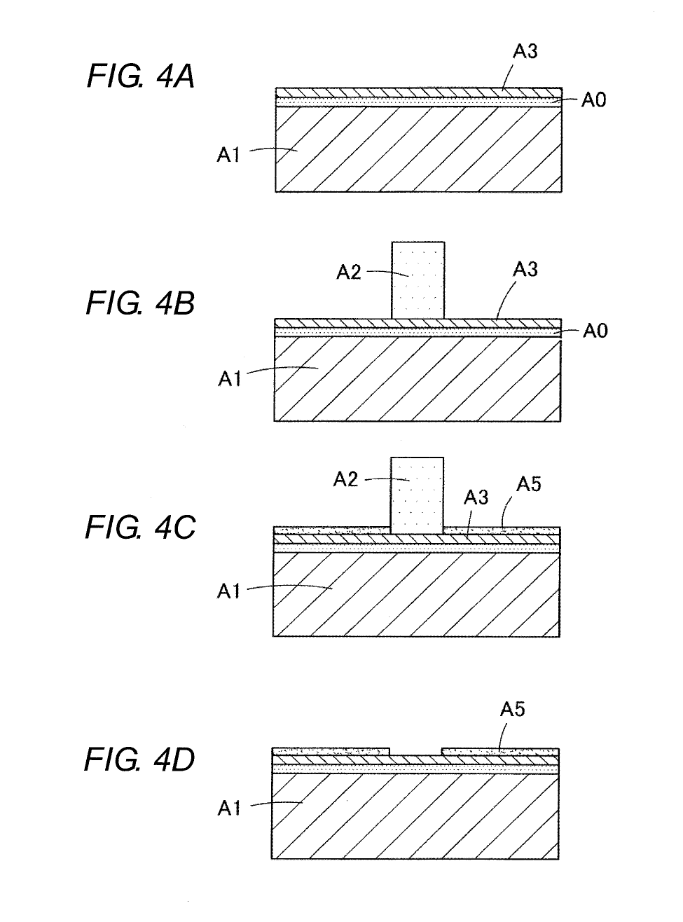

The switch 31 can be manufactured as shown in FIGS. 4A to 4D, FIGS. 5A to 5C, and FIGS. 6A to 6C. In the second manufacturing method as well, the plated base layer A3 is first formed on the substrate A1, having a surface being covered with the insulating layer A0, as shown in FIG. 4A.

Then, as shown in FIG. 4B, the mold portion A2 is arranged in a region other than the region to form the wiring patterns 48, 58 at the upper surface of the plated base layer A3. After forming the conductive layer A5 in the region exposed from the mold portion A2 of the plated base layer A3 by the plating process as shown in FIG. 4C, the mold portion A2 is once removed as shown in FIG. 4D.

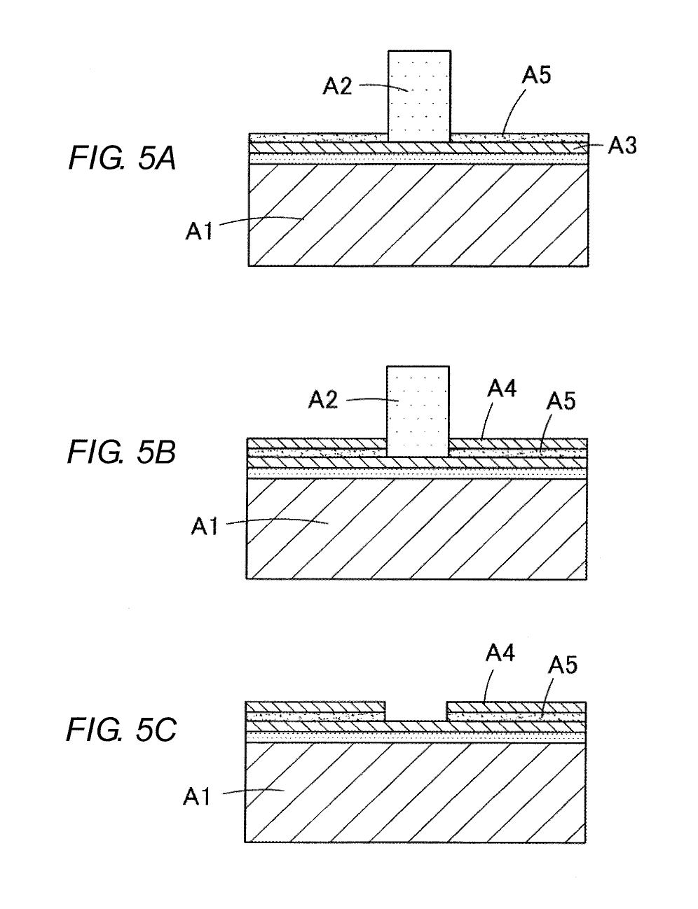

Furthermore, as shown in FIG. 5A, the mold portion A2 is newly arranged in the region where the plated base layer A3 is exposed, and then the buffer layer A4 is stacked on the conductive layer A5 by the plating process as shown in FIG. 5B. Then, the mold portion A2 is again removed as shown in FIG. 5C.

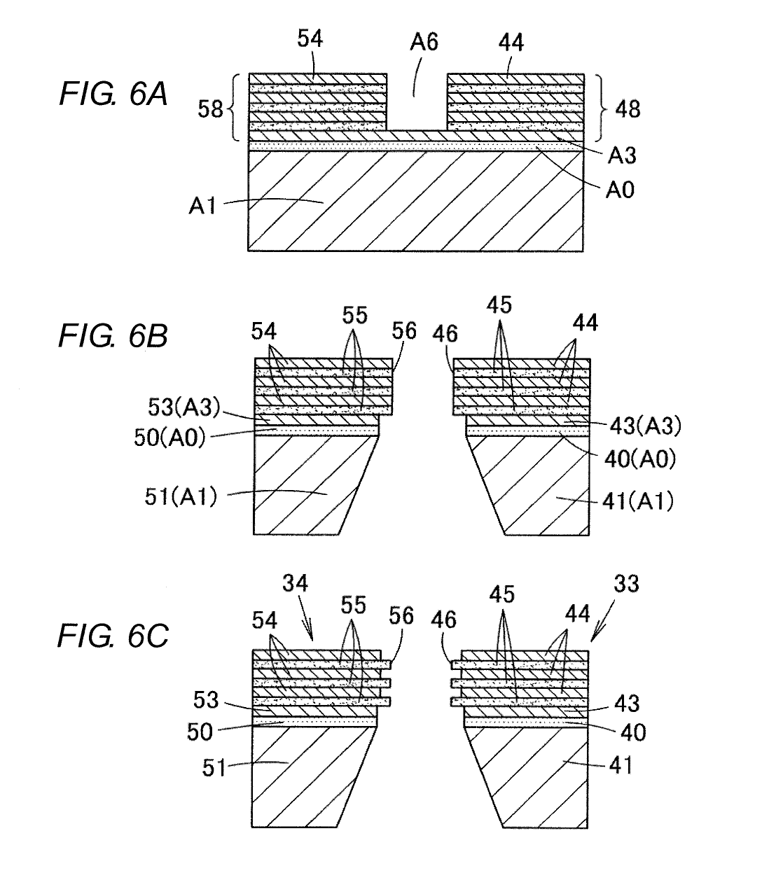

The process of forming a new mold portion A2 and forming the conductive layer A5 as shown in FIGS. 4B to 4D, and the process of forming a new A2 and forming the buffer layer A4 as shown in FIGS. 5A to 5C are alternately repeated a number of times to form the wiring patterns 48, 58 on the substrate A1 as shown in FIG. 6A.

Thereafter, the exposed portion of the plated base layer A3 and the insulating layer A0 is removed by etching from the space A6, and the substrate A1 is etched from the lower surface side to be divided to the fixed contact substrate 41 and the movable contact substrate 51, as shown in FIG. 6B. After the end of the buffer layer 44 is selectively etched by the etchant entered into the space A6 between the wiring patterns 48 and 58, the buffer layer 44 is etched back, the ends of the conductive layers 45, 55 are projected out, and the fixed contact 46 and the movable contact 56 are formed at the end faces thereof, as shown in FIG. 6C. The buffer layer 44 is etched back after the plated base layer A3, the insulating layer A0 and the substrate A1 are divided, but the plated base layer A3, the insulating layer A0 and the substrate A1 may be divided after the buffer layer 44 is etched back.

In the second manufacturing method, the mold portion A2 damaged by etchant and the like is removed and a new mold portion A2 is formed so that the conductive layer A5 is formed using the new mold portion A2 each time, and thus the end face of the conductive layer A5 of each layer can be formed more smoothly.

(Effects)

In the switch 31 according to one or more embodiments of the present invention, the contacting surfaces of each contact 46, 56 can be smoothly formed by the side surface of the mold portion since the contacting surface of the fixed contact 46 and the contacting surface of the movable contact 56 are parallel in the growing direction of the conductive layer A5. The parallelism of the contacting surfaces of the contacts 46, 56 is also enhanced. Therefore, the contact resistance in the case where the contacts 46, 56 are coming into contact with each other can be reduced.

Furthermore, stripping is less likely to occur even if the conductive layers 45, 55 are formed from a material having a high hardness since the conductive layers 45, 55 forming the contacts 46, 56 have a multi-layered structure and the buffer layers 44, 54 having a lower hardness than the conductive layers 45, 55 are arranged between the conductive layers 45, 55. Therefore, the welding of the contacts 46, 56 can be prevented by forming the conductive layers 45, 55 with a material having a high hardness. Furthermore, the conductive layers 45, 55 are multi-layered and the opposing area of the contacts 46, 56 can be increased so that the contacting position of the contacts can be dispersed and the breakage of the contact contacting part is less likely to occur. Thus, the open/close lifespan of the switch 31 extends and the inter-contact distance can be narrowed. Furthermore, the contact stability of the contacts is enhanced even if the operation of the movable contact portion 34 varies since the opposing area of the contacts 46, 65 becomes large.

The total area of the fixed contact 46 can be increased by increasing the number of layers of the conductive layer 45 since a plurality of conductive layers 45 is stacked and the end face of each conductive layer 45 serves as the fixed contact 46. Similarly, the total area of the movable contact 56 can be increased by increasing the number of layers of the conductive layer 55 since a plurality of conductive layers 55 is stacked and the end face of each conductive layer 55 serves as the movable contact 56. Moreover, the wiring resistance of the wiring pattern 48 and the wiring pattern 58 also becomes small since the total cross-sectional area of the cross-section perpendicular to the length direction of the conductive layer 45 and the conductive layer 55 becomes large. As the wiring patterns 48 and 48 are formed by alternately stacking the conductive layers 45, 55 and the buffer layers 44, 54, the warpage caused by the internal stress and the like can be suppressed and the conductive layers 44, 55 are less likely to strip from the substrates 41, 51, compared to when only one conductive layer having a thickness same as the total thickness of the conductive layers 44, 55 is arranged.

The sticking of the contacts 46, 56 can be prevented by forming the conductive layers 45, 55 with a material of high hardness. The impact at the time of contact of the contacts 46, 56 can be alleviated with the buffer layers 44, 45 and the stress of the conductive layers 45, 55 can be alleviated thereby reducing the distortion by forming the buffer layers 44, 45 with a material having lower hardness than the conductive layers 45, 55, so that the stripping of the conductive layers 45, 55 can be prevented.

Furthermore, the fixed contact 46 and the movable contact 56 can reliably come into contact with each other without being inhibited by the buffer layers 44, 54 and the base layers 43, 53 since the fixed contact 46 and the movable contact 56 are projected out from the end faces of the buffer layers 44, 54 and the base layers 43, 53. As the buffer layer 44 and the buffer layer 54 do not come into contact with each other, the buffer layer 44 and the conductive layer 55 do not come into contact with each other, nor the buffer layer 54 and the conductive layer 45 come into contact with each other, the sticking thereof can be prevented.

If the thickness of the conductive layers 45, 55 is thicker than the thickness of the buffer layers 44, 54, the fixed contact portion 33 and the movable contact portion 34 can be prevented from sticking when the end of the conductive layer 45 enters the gap between the conductive layers 55 or when the end of the conductive layer 55 enters the gap between the conductive layers 45 even if the positions of the contacts 46, 56 are shifted.

Moreover, the variation in the gap distance of the fixed contact 46 and the movable contact 56 can be reduced and the inter-contact distance can be narrowed since the conductive layers 45, 55 are formed using the MEMS technique.

### Second Embodiment

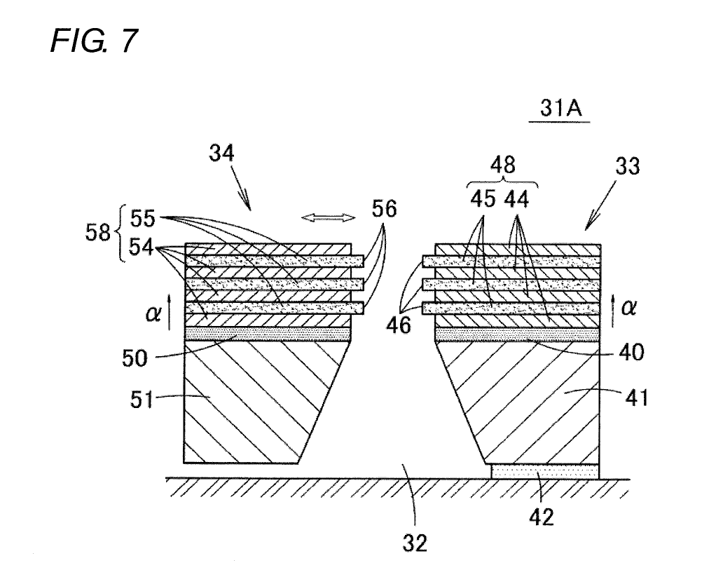

FIG. 7 is a cross-sectional view showing a structure of a switch 31A according to a second embodiment of the present invention. In such a switch 31A, the base layer 43 is not used, and the buffer layers 44, 54 and the conductive layers 45, 55 are alternately stacked on the upper surfaces of the insulating layer 40 and the insulating layer 50 starting from the buffer layers 44, 54.

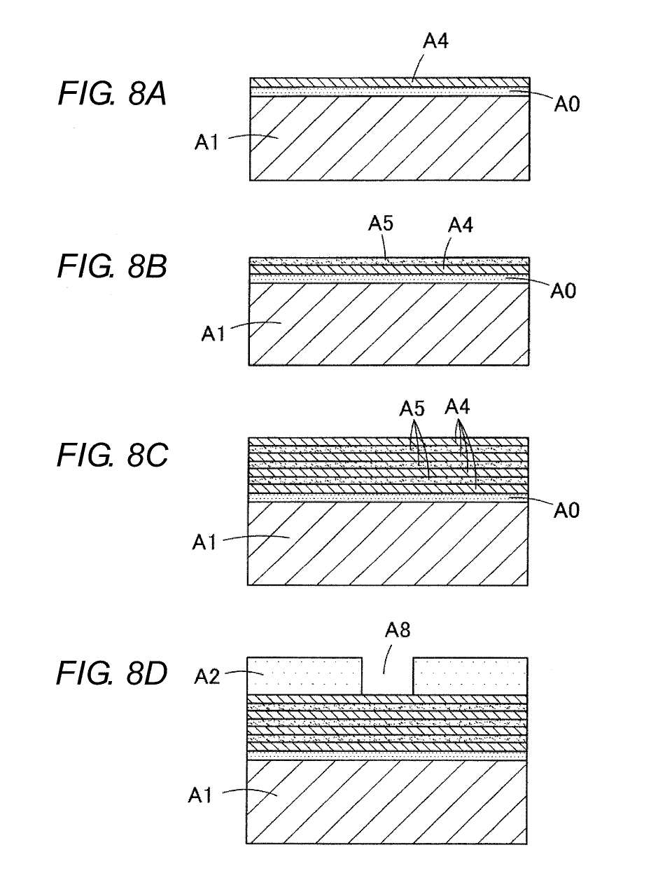

FIGS. 8A to 8D, FIGS. 9A to 9C, and FIGS. 10A to 100 are cross-sectional views showing the manufacturing process of the switch 31A. This manufacturing method forms the wiring patterns 48, 58 by vapor deposition, sputtering, and the like.

First, as shown in FIG. 8A, the upper surface of the substrate A1 is covered with the insulating layer A0, the buffer layer A4 is formed on the upper surface of the insulating layer A0 through methods such as vapor deposition, sputtering, and non-electrolytic plating, and then the conductive layer A5 is formed on the upper surface of the buffer layer A4 through methods such as vapor deposition, sputtering, and electrolytic plating as shown in FIG. 8B. Furthermore, the process of FIG. 8A (may be electrolytic plating in this case) and the process of FIG. 8B are repeated to stack a predetermined number of buffer layer A4 and conductive layer A5 as shown in FIG. 8C.

Rather than directly arranging the buffer layer 44 at the lowermost layer on the upper surface of the insulating layer A0, an adhesive layer (e.g., two-layer structure including lower layer Cr/upper layer Au) for enhancing the adhesion strength (stripping strength) of the insulating layer A0 and the buffer layer A4 may be formed between the insulating layer A0 and the buffer layer A4. Alternatively, an adhesive layer e.g., two-layer structure including lower layer Cr/upper layer Au) for enhancing the adhesion strength (stripping strength) of the insulating layer A0 and the conductive layer A5 may be formed between the insulating layer A0 and the conductive layer A5 of the lowermost layer in place of the buffer layer A4 of the lowermost layer.

Thereafter, the photoresist is applied on the buffer layer A4 of the uppermost layer and patterned to form the mold portion A2 in the region to form the wiring patterns 48 and 58, as shown in FIG. 8D.

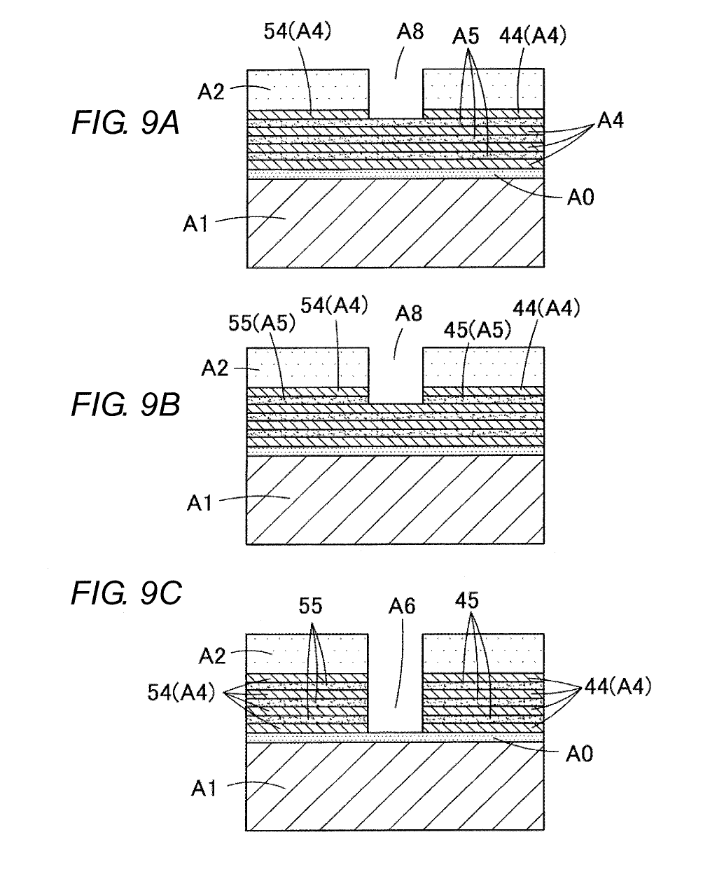

Then, the buffer layer A4 of the uppermost layer is removed by etching in the exposed region A8 from the mold portion A2 as shown in FIG. 9A, and the conductive layer A5 is removed by etching in the exposed region A8 from the buffer layer A4 of the uppermost layer as shown in FIG. 9B. The process of FIG. 9A and the process of FIG. 9B are repeated to remove all the buffer layers A4 and the conductive layers A5 other than in the region to form the wiring patterns 48 and 58 to expose the insulating layer A0, as shown in FIG. 9C.

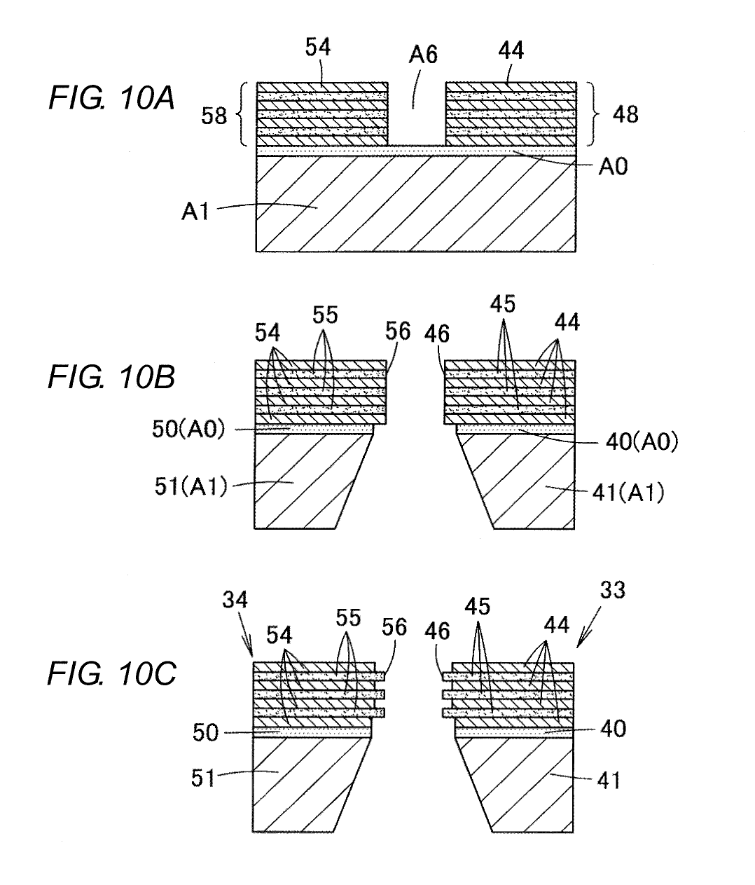

After the wiring patterns 48 and 58 are formed above the substrate A1 in such manner, the mold portion A2 thereon is removed by etching as shown in FIG. 10A.

Thereafter, the exposed region of the insulating layer A0 is removed by etching from the space A6, and A0 is divided to the insulating layer 40 and the insulating layer 50. The substrate A1 is etched from the lower surface side and divided to the fixed contact substrate 41 and the movable contact substrate 51 as shown in FIG. 10B. After the end of the buffer layers 44, 54 are selectively etched by the etchant entered into the space A6 between the wiring pattern 48 and the wiring pattern 58, the buffer layers 44, 54 are etched back, the ends of the conductive layers 45, 55 are projected out, and the fixed contact 46 and the movable contact 56 are formed at the end faces thereof, as shown in FIG. 10B. The buffer layer 44 is etched back after dividing the insulating layer A0 and the substrate A1, but the insulating layer A0 and the substrate A1 may be divided after the buffer layer 44 is etched back.

Therefore, one block becomes the fixed contact portion 33 in which the buffer layer 44 and the conductive layer 45 are alternately stacked on the fixed contact substrate 41 having the surface covered with the insulating layer 40. The fixed contact portion 33 is fixed on the upper surface of the base substrate 32 through the insulating film 42. The other block becomes the movable contact portion 34 in which the buffer layer 54 and the conductive layer 55 are alternately stacked on the movable contact substrate 51 having the surface covered with the insulating layer 50. The movable contact portion 34 is lastly separated from the base substrate 32 by removing the insulating film at the lower surface by etching thereby forming the switch 31A.

### Third Embodiment

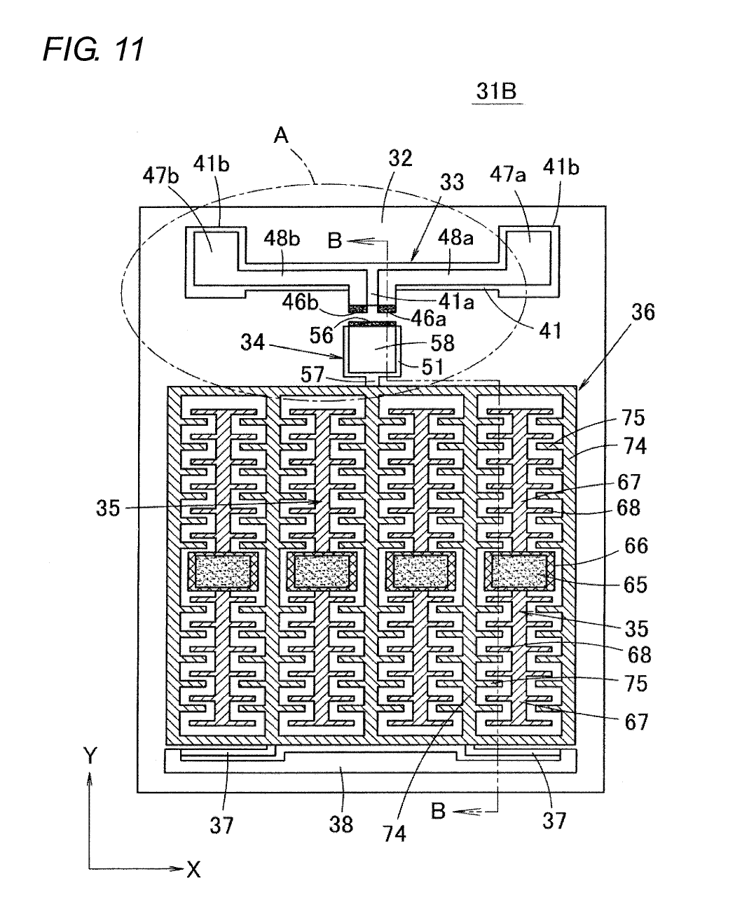

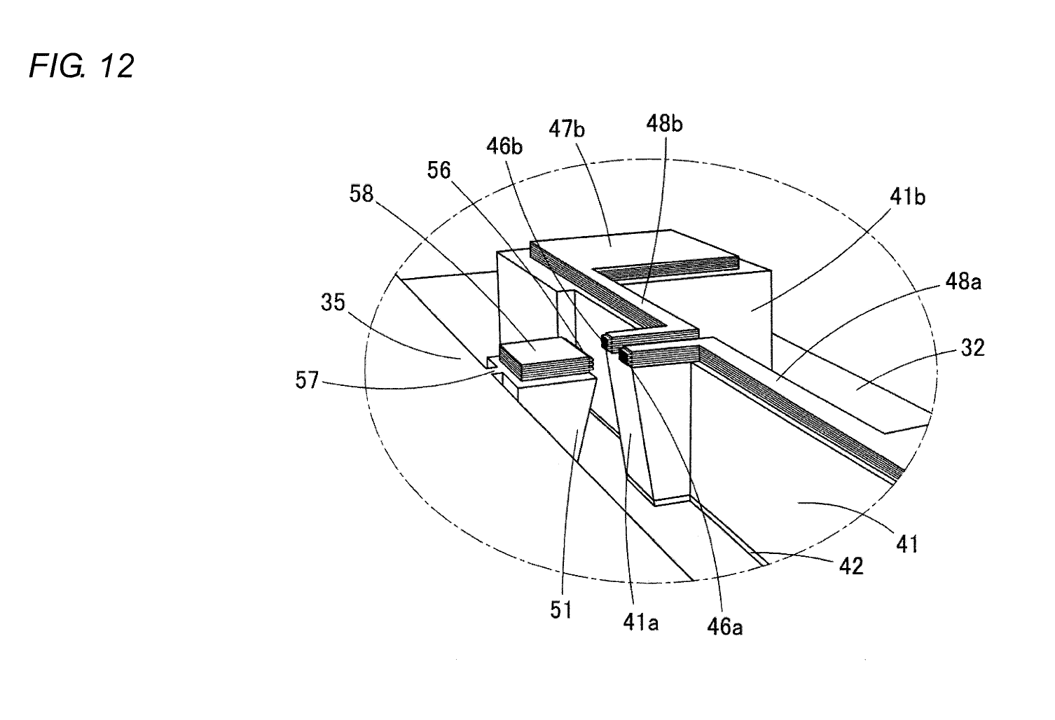

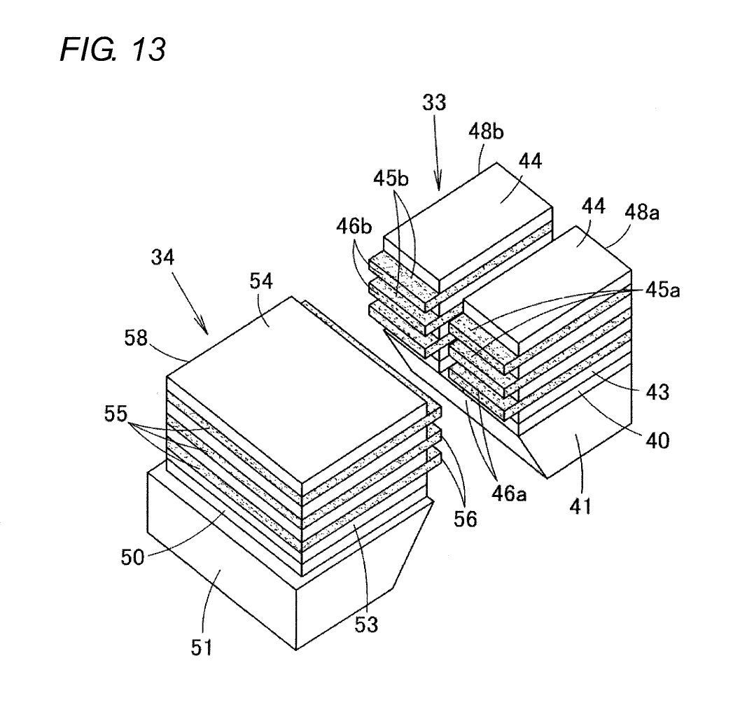

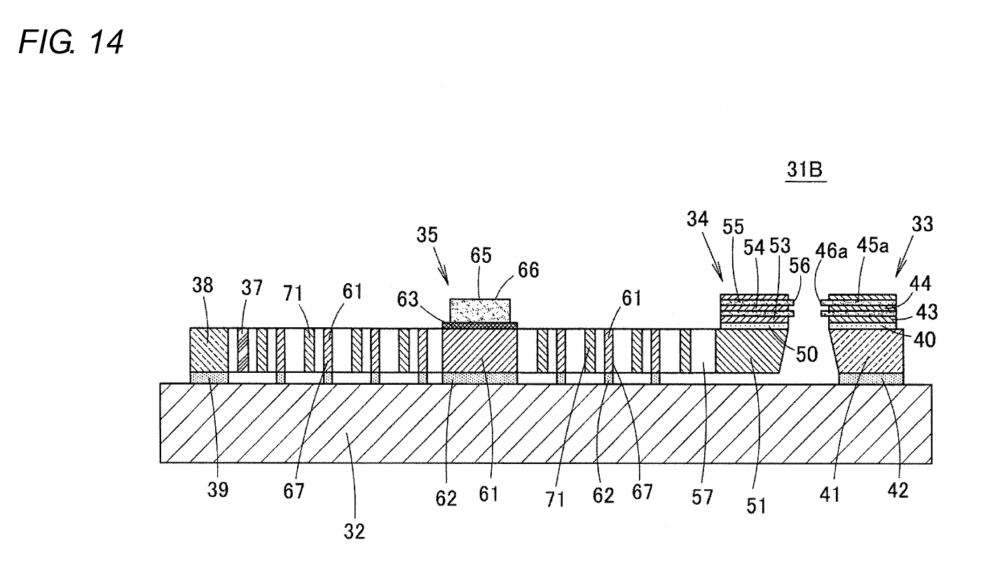

The structure of an electrostatic relay 31B for high frequency according to a third embodiment of the present invention will now be described. FIG. 11 is a plan view showing the structure of the electrostatic relay 31B. FIG. 12 is a perspective view showing portion A of FIG. 11 in an enlarged manner, and FIG. 13 is a perspective view showing the fixed contact portion 33 and the movable contact portion 34 in an enlarged manner. FIG. 14 is a schematic cross-sectional view taken along line B-B of FIG. 11.

The electrostatic relay 31B is provided with the fixed contact portion 33, the movable contact portion 34, a fixed electrode portion 35, a movable electrode portion 36 for supporting the movable contact portion 34, an elastic spring 37, and a supporting portion 38 for supporting the elastic spring 37 arranged on the upper surface of the base substrate 32 including the Si substrate, the glass substrate, or the like.

As shown in FIG. 14, the fixed contact portion 33 has the lower surface of the fixed contact substrate 41 made of Si fixed to the upper surface of the base substrate 32 by the insulating film 42 (SiO2). As shown in FIG. 13, the surface of the fixed contact substrate 41 is covered with the insulating layer 40, the base layer 43 including the lower layer Cr/upper layer Au is formed on the upper surface thereof, and the buffer layer 44 and the conductive layers 45a, 45b of Pt and the like are alternately stacked on the base layer 43.

As shown in FIG. 11 and FIG. 12, the fixed contact substrate 41 extends in the width direction (X direction) at the end on the upper surface of the base substrate 32, where a bulging-out portion 41a projecting out towards the movable contact portion 34 side is formed at the central part and pad supporting portions 41b, 41b are formed at both ends. The wiring patterns 48a, 48b are wired along the upper surface of the fixed contact substrate 41, where one ends of the wiring patterns 48a, 48b are arranged parallel to each other on the upper surface of the bulging-out portion 41a, and the distal end faces of the conductive layers 45a, 45b projecting out from the end face of the bulging-out portion 41a are positioned in the same plane to become fixed contacts 46a, 46b (electrical contacting surface). Metal pad portions 47a, 47b are formed on the upper surface of the pad supporting portions 41b, 41b at the other ends of the wiring patterns 48a, 48b.

The movable contact portion 34 is arranged at a position facing the bulging-out portion 41a. As shown in FIG. 14, the movable contact portion 34 has the surface of the movable contact substrate 51 made of Si covered with the insulating layer 50, the base layer 53 including the lower layer Cr/upper layer Au formed on the upper surface thereof, and the buffer layer 54 and the conductive layer 55 of Pt and the like alternately stacked on the base layer 53. As shown in FIG. 13, the end face of the conductive layer 55 facing the conductive layers 45a, 45b projects out from the front surface of the movable contact substrate 51 and is formed parallel to the fixed contact 46a, 46b, whereby the relevant end face becomes the movable contact 56 (electrical contacting surface). The movable contact 56 has a width substantially equal to the distance from the edge on the outer side of the fixed contact 46a to the edge on the outer side of the fixed contact 46b.

The movable contact substrate 51 is supported in a cantilever manner by a supporting beam 57 projecting out from the movable electrode portion 36. The lower surfaces of the movable contact substrate 51 and the supporting beam 57 are floating from the upper surface of the base substrate 32, and can move parallel to the length direction (Y direction) of the base substrate 32 with the movable electrode portion 36.

In the electrostatic relay 31B, a main circuit (not shown) is connected to the metal pad portions 47a, 47b of the fixed contact portion 33, where the main circuit can be closed by contacting the movable contact 56 to the fixed contacts 46a, 46b, and the main circuit can be opened by separating the movable contact 56 from the fixed contacts 46a, 46b. The opposing surfaces of the bulging-out portion 41a and the movable contact substrate 51 are inclined to retreat towards the lower side, and the fixed contacts 46a, 46b are projected out than the bulging-out portion 41a and the movable contact 56 is also projected out from the movable contact substrate 51, so that the bulging-out portion 41a and the movable contact substrate 51 do not come into contact with each other when closing the contacts thereby preventing the movable contact 56 and the fixed contacts 46a, 46b from causing contact failure.

The actuator for moving the movable contact portion 34 is configured by the fixed electrode portion 35, the movable electrode portion 36, the elastic spring 37, and the supporting portion 38.

As shown in FIG. 11, a plurality of fixed electrode portions 35 is arranged in parallel to each other on the upper surface of the base substrate 32. In plan view, the fixed electrode portion 35 has a branch-like electrode part 67 of a branch-shape extending in the Y direction from both surfaces of a rectangular pad portion 66. The branch-like electrode part 67 has a branch portion 68 projecting out so as to be symmetrical to each other, which branch portion 68 is lined at a constant pitch in the Y-direction.

As shown in FIG. 14, the lower surface of a fixed electrode substrate 61 is fixed to the upper surface of the base substrate 32 by the insulating film 62 in the fixed electrode portion 35. In the pad portion 66, the fixed electrode 63 is formed by Cu, Al, and the like on the upper surface of the fixed electrode substrate 61, and an electrode pad layer 65 is arranged on the fixed electrode 63.

As shown in FIG. 11, the movable electrode portion 36 is formed to surround each fixed electrode portion 35. The movable electrode portion 36 includes a comb teeth like electrode portion 74 formed so as to sandwich each fixed electrode portion 35 from both sides (branch-shape by a pair of comb teeth like electrode portions 74 between the fixed electrode portions 35). The comb teeth like electrode portion 74 is symmetric with each fixed electrode portion 35 as the center, where a comb teeth part 75 extends from each comb teeth like electrode portion 74 to a clearance between the branch portions 68. Furthermore, each comb teeth part 75 has the distance with the branch portion 68 positioned on the side close to the movable contact portion 34 adjacent to the comb teeth part 75 shorter than the distance with the branch portion 68 positioned on the side distant from the movable contact portion 34 adjacent to the comb teeth part 75.

The movable electrode portion 36 includes a movable electrode substrate 71 of Si, where the lower surface of the movable electrode substrate 71 is floating from the upper surface of the base substrate 32. The supporting beam 57 is arranged in a projecting manner at the center of the end face on the movable contact side of the movable electrode portion 36, and the movable contact portion 34 is held at the distal end of the supporting beam 57.

The supporting portion 38 is made of Si, and extends long in the X direction at the other end of the base substrate 32. The lower surface of the supporting portion 38 is fixed to the upper surface of the base substrate 32 by the insulating film 39. Both ends of the supporting portion 38 and the movable electrode portion 36 (movable electrode substrate 71) are connected by a pair of elastic springs 37 formed symmetrically by Si, where the movable electrode portion 36 is horizontally supported by the supporting portion 38 by way of the elastic spring 37. The movable electrode portion 36 is movable in the Y direction by elastically deforming the elastic spring 37.

In the electrostatic relay 31B having the above structure, a DC voltage source is connected between the fixed electrode portion 35 and the movable electrode portion 36, and the DC voltage is turned ON and OFF by the control circuit and the like. In the fixed electrode portion 35, one terminal of the DC voltage source is connected to the electrode pad layer 65. The other terminal of the DC voltage source is connected to the supporting portion 38. The supporting portion 38 and the elastic spring 37 have conductivity, and the supporting portion 38, the elastic spring 37, and the movable electrode portion 36 are electrically conducted, and hence the voltage applied to the supporting portion 38 will be applied to the movable electrode portion 36.

When the DC voltage is applied between the fixed electrode portion 35 and the movable electrode portion 36 by the DC voltage source, an electrostatic attractive force is generated between the branch portion 68 of the branch like electrode part 67 and the comb teeth part 75 of the comb teeth like electrode portion 74. However, the electrostatic attractive force in the X direction acting on the movable electrode portion 36 becomes balanced since the structure of the fixed electrode portion 35 and the movable electrode portion 36 is formed symmetric with respect to the center line of each fixed electrode portion 35, whereby the movable electrode portion 36 does not move in the X direction. Since the distance with the branch portion 68 positioned on the side close to the movable contact portion 34 adjacent to the comb teeth part 75 is shorter than the distance with the branch portion 68 positioned on the side distant from the movable contact portion 34 adjacent to the comb teeth part 75, each comb teeth part 75 is attracted to the movable contact portion side, and the movable electrode portion 36 moves in the Y direction while bending the elastic spring 37. As a result, the movable contact portion 34 moves to the fixed contact portion 33 side, and the movable contact 56 comes into contact with the fixed contacts 46a, 46b thereby electrically closing the fixed contact 46a and the fixed contact 46b (main circuit).

When the DC voltage applied between the fixed electrode portion 35 and the movable electrode portion 36 is released, the electrostatic attractive force between the branch portion 68 and the comb teeth part 75 disappears, whereby the movable electrode portion 36 moves backward in the Y direction by the elastic returning force of the elastic spring 37 thereby separating the movable contact 56 from the fixed contacts 46a, 46b and opening the fixed contact 46a and the fixed contact 46b (main circuit).

Such electrostatic relay 31B is formed through the following steps. First, the Si substrate (another Si wafer having conductivity) is joined to the upper surface of the base substrate 32 (Si wafer, SOI wafer, etc.) having the entire surface covered with the insulating film, and the metal material is vapor deposited on the upper surface of the Si substrate to form the electrode film. The electrode film is then patterned by the photolithography technique, and the fixed electrode 63 is formed on the upper surface of the fixed electrode substrate 61 at the pad portion 66 by the electrode film.

Thereafter, the insulating layer and the base layer are formed on the upper surface of the Si substrate from above the electrode film, and a predetermined number of buffer layers and conductive layers are alternately stacked thereon. The conductive layer and the buffer layer are then patterned to form the wiring pattern 48 of the fixed contact portion 33 and the wiring pattern 58 of the movable contact portion 34. The electrode pad layer 65 is formed on the fixed electrode 63 in the pad portion 66. The conductive layer and the buffer layer are removed through etching while leaving the base layer and the insulating layer at the lower surface of the wiring patterns 48, 58, where the base layers 43, 53 are formed from the remaining base layer and the insulating layers 40, 50 are formed from the remaining insulating layer.

Thereafter, a photoresist is applied on the wiring patterns 48a, 48b, the wiring pattern 58, the fixed electrode 63, and the like to form a resist mask, the Si substrate is etched through the resist mask, and the fixed contact substrate 41 of the fixed contact portion 33, the movable contact substrate 51 of the movable contact portion 34, the fixed electrode substrate 61 of the fixed electrode portion 35, the movable electrode substrate 71 of the movable electrode portion 36, the elastic spring 37, and the supporting portion 38 are formed from the Si substrate remaining in each region.

Lastly, the insulating film of the region exposed from the Si substrate and the insulating film at the lower surfaces of the movable contact portion 34 and the movable electrode portion 36 are removed through etching, and then cut to individual electrostatic relay 31B.

In the manufacturing step of the electrostatic relay 31B, the movable contact portion 34 and the fixed electrode portion 35 are formed through steps similar to the steps shown in FIG. 2 and FIG. 3 or FIG. 4 to FIG. 6, and hence the fixed contacts 46a, 46b of the fixed contact portion 33 and the movable contact 56 of the movable contact portion 34 become side surfaces parallel to the growing direction of the conductive layer, and a contact having satisfactory smoothness and parallelism can be obtained without performing grinding and the like. Effects similar to the switch 31 of the first embodiment thus can be obtained in the electrostatic relay 31B as well.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A switch comprising;
a first contact portion in which a plurality of conductive layers are stacked on an upper side of a first substrate, and
a second contact portion in which a plurality of conductive layers are stacked on an upper side of a second substrate; wherein
respective end faces of the conductive layers at the first contact portion are contacts of the first contact portion;
respective end faces of the conductive layers at the second contact portion are contacts of the second contact portion; and
each contact of the first contact portion and each contact of the second contact portion are faced to each other so that the contacts come into contact with or separate from each other.

2. The switch according to claim 1, wherein the conductive layer and a buffer layer having a hardness smaller than the conductive layer are alternately stacked with each other in the first contact portion and the second contact portion.

3. The switch according to claim 2, wherein the end face to become the contact in the conductive layer is projected out than an end face of the buffer layer in the first contact portion and the second contact portion.

4. The switch according to claim 2, wherein a thickness of the conductive layer configuring the first contact portion is thicker than a thickness of the buffer layer configuring the second contact portion.

5. The switch according to claim 2, wherein a thickness of the conductive layer configuring the second contact portion is thicker than a thickness of the buffer layer configuring the first contact portion.

6. The switch according to claim 1, wherein the conductive layer in the first contact portion and the second contact portion is made of Pt, Pd, Ir, Ru, Rh, Re, Ta, Ag, Ni, Au, or an alloy thereof.

7. A method of manufacturing a switch comprising the steps of:
forming a mold portion of a predetermined pattern on an upper side of a substrate;
alternately stacking buffer layers and conductive layers on an upper side of the substrate by growing the buffer layers and the conductive layers in a thickness direction of the substrate in a plurality of regions excluding a region formed with the mold portion at the upper side of the substrate;
removing the mold portion and forming a surface to become a contact with a surface coming into contact with a side surface of the mold portion of the conductive layer; and
dividing the substrate into plurals in accordance with the plurality of regions in which the buffer layers and the conductive layers are stacked.

8. A method of manufacturing a switch comprising the steps of:
alternately stacking buffer layers and conductive layers on an upper side of a substrate by growing the buffer layers and the conductive layers in a thickness direction of the substrate at the upper side of the substrate;
forming a mold portion of a plurality of regions on the stacked buffer layers and the conductive layers;
etching the buffer layers and the conductive layers with the mold portion as a mask to divide the buffer layers and the conductive layers into plurals and forming a surface to become a contact with the etched surface of the conductive layer; and
dividing the substrate into plurals in accordance with the divided regions of the buffer layers and the conductive layers.

9. An electrostatic relay comprising the switch according to claim 1, and an actuator for moving at least one contact portion of the first contact portion and the second contact portion in a direction perpendicular to the contact thereof to so that the contact of the first contact portion and the contact of the second contact portion are brought into contact with or separated from each other.
